(19) United States
(12) Patent Application Publication
(10) Pub. No.: US 2013/0118007 A1
(43) Pub. Date: May 16, 2013

(54) FIXTURE FOR INSTALLING HARD DISK

(71) Applicants: CHIN-WEN YEH, Tu-Cheng (TW); ZHI-JIAN PENG, Wuhan City (CN); YANG XIAO, Wuhan City (CN); KAI PEI, Wuhan City (CN)

(72) Inventors: CHIN-WEN YEH, Tu-Cheng (TW); ZHI-JIAN PENG, Wuhan City (CN); YANG XIAO, Wuhan City (CN); KAI PEI, Wuhan City (CN)

(21) Appl. No.: 13/632,247

(22) Filed: Oct. 1, 2012

(30) Foreign Application Priority Data
Nov. 14, 2011 (CN) 201110359008.3

(51) Int. Cl. B23P 19/04

(52) U.S. Cl. 29/758

(57) ABSTRACT

A fixture is for installing a hard disk to a hard disk cage in a computer the fixture. The fixture includes a holding portion and a supporting portion connecting with the holding portion. The supporting portion includes a main plate and a side plate bending from the main plate. A slot is defined between the main plate and the side plate, for receiving the hard disk cage and retaining the fixture to the hard disk cage.

### BACKGROUND

1. Technical Field

The disclosure relates to fixtures, and particularly to a fixture for installing a hard disk.

2. Description of Related Art

Typical hard disks in computers have two different sizes, one is 2.5 inches, and the other is 3.5 inches. The hard disks are positioned in hard disk cages in the computers. However, the hard disk cage in the computer just directly positions the hard disk with only one size. If the hard disk with another size needs to be installed into the hard disk cage, it will need an operator hold the hard disk by hand, which increases work intension of the operator, and lows installation efficiency.

What is needed, therefore, is a fixture for installing a hard disk which can overcome the described limitations.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a schematic view of a fixture for installing a hard disk in accordance with a first embodiment of the disclosure.

FIG. 2 is a view of the fixture similar to FIG. 1, but viewed from another aspect.

FIG. 3 is a schematic view of the fixture of FIG. 1 with a hard disk before being installed into a computer.

FIG. 4 is a schematic view of the fixture of FIG. 1 installing a hard disk into a computer.

### DETAILED DESCRIPTION

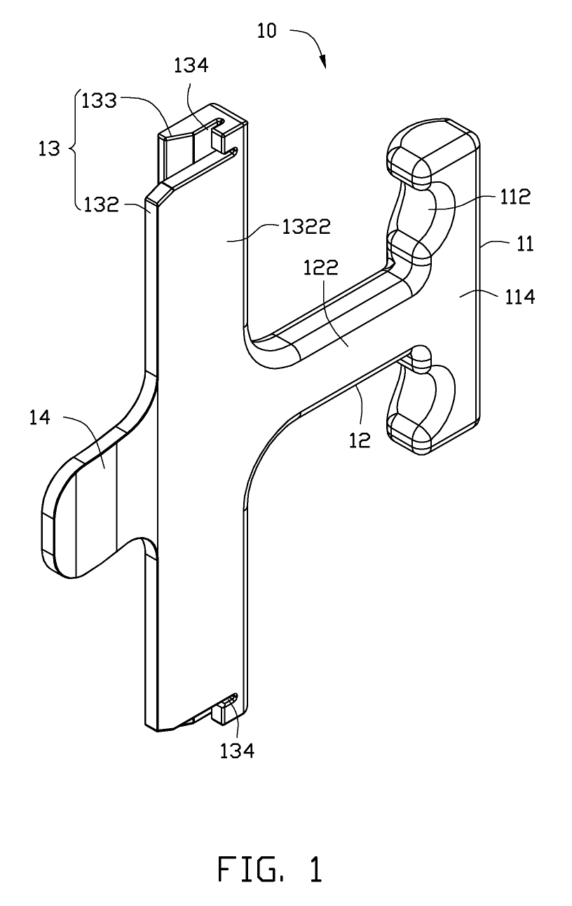

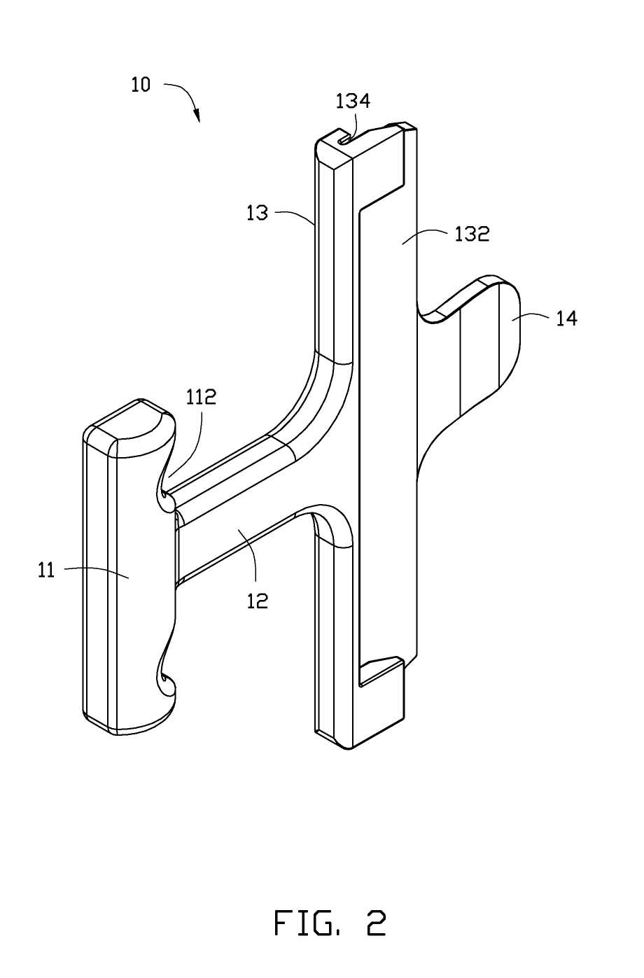

Referring to FIGS. 1-3, a fixture 10 in accordance with an embodiment of the disclosure is used for installing a hard disk 20 into a computer 30. The fixture 10 includes a holding portion 11, a supporting portion 13 and a connecting portion 12 located between the holding portion 11 and the supporting portion 13.

The holding portion 11 has a strip structure with two concaves 112 defined therein, for facilitating an operator to hold the holding portion 11 with fingers. The two concaves 112 are spaced and adjacent to two opposite ends of the holding portion 11, respectively. In this embodiment, the holding portion 11 includes a plane surface 114 and a plurality of smooth surfaces connecting with the surface 114.

The connecting portion 12 has a bar structure with an end thereof connecting with a middle part of the holding portion 11. The end of the connecting portion 12 is located between the two concaves 112 of the holding portion 11. Alternatively, the connecting portion 12 can connect with an end of the holding portion 11. The connecting portion 12 includes a surface 122 located at a same side with the surface 114 of the holding portion 11. The surface 122 is a plane and coplanar with the surface 114.

The supporting portion 13 connects with another end of the connecting portion 12, i.e., the supporting portion 13 connects with the holding portion 11 by the connecting portion 12. In this embodiment, the connecting portion 12 is between the middle part of the holding portion 11 and a middle part of the supporting portion 13. The supporting portion 13 faces the concaves 112 of the holding portion 11. The supporting portion 13 includes a main plate 132 and a side plate 133 bending from the main plate 132. The side plate 133 has a part substantially parallel to the main plate 132. Two slots 134 are defined between corresponding ends of the main plate 132 and the side plate 133. The main plate 132 includes a plane surface 1322 coplanar with the surface 114 of the holding portion 11. Each of the two slots 134 is located adjacent to the connecting portion 12.

It can be understood that, the connecting portion 12 of the fixture 10 can be omitted, the holding portion 11 and the supporting portion 13 can be directly connected with each other.

The fixture 10 further includes an abutting portion 14 located a side of the supporting portion 13 opposite to the holding portion 11 and the connecting portion 12. In this embodiment, the abutting portion 14 is smaller than the supporting portion 13 in size. The abutting portion 14 has a substantially rectangular structure and extends outwardly from a middle part of the side of the supporting portion 13. The abutting portion 14 is corresponding to the connecting portion 12. The abutting portion 14 tilts toward the surface 1322 of the supporting portion 13 for increasing elastic pressure to the hard disk 20 when the hard disk 20 is positioned to the computer 30.

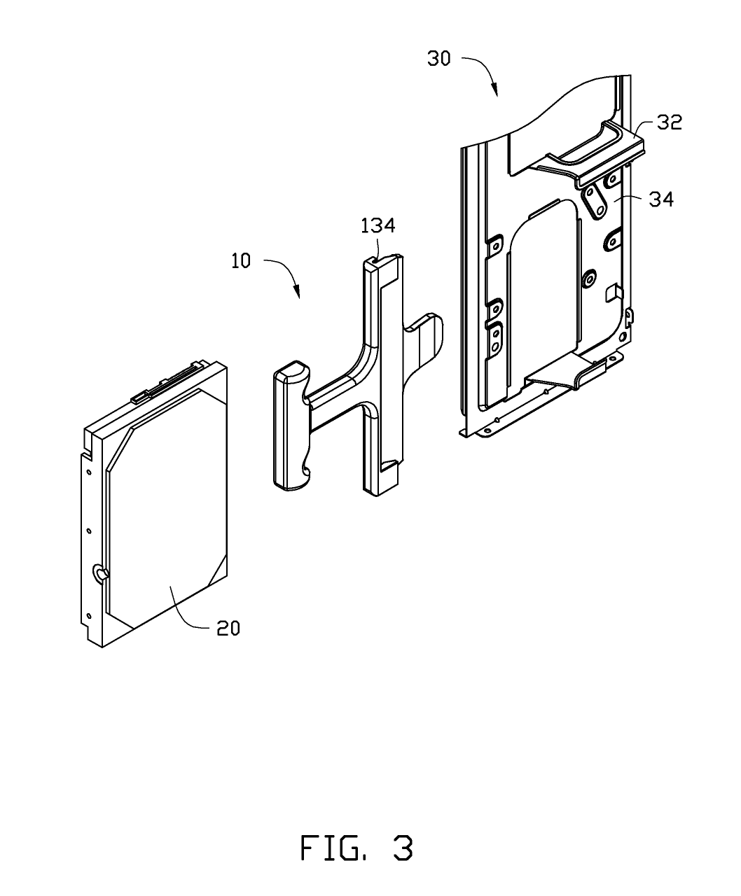

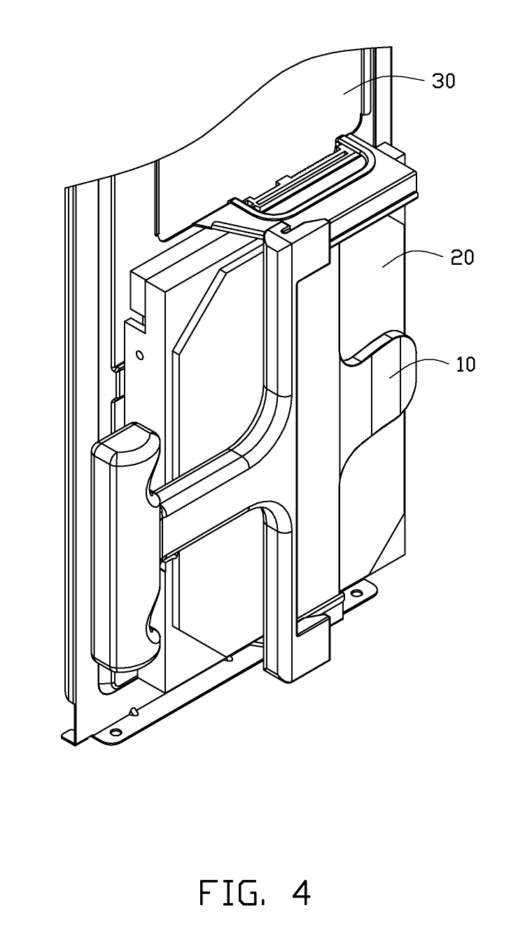

Referring to FIGS. 3 and 4, when the fixture 10 is applied to install the hard disk 20 to a hard disk cage 32 extending from a sidewall 34 of the computer 30, the fixture 10 is inserted into the computer 30, the hard disk cage 32 has two portions thereof engaged in the slots 134 of the supporting portion 13, the main plate 132 and the side plate 133 of the fixture 10 sandwich the portions of the hard disk cage 32 therebetween. Therefore, the fixture 10 is retained to the hard disk cage 32 with the main plate 132 substantially parallel the sidewall 34. The surfaces 114, 122 and 1322 of the fixture 10 face the sidewall 34. The hard disk 20 is positioned between the fixture 10 and the sidewall 34, and is inserted into the hard disk cage 32 along the surfaces 114, 122 and 1322 of the fixture 10. It can be understood that, after the hard disk 20 is inserted into the hard disk cage 32, the hard disk 20 can be further fixed to the hard disk cage 32.

According to the disclosure, during a installation of the hard disk 20 to the hard disk cage 32, the fixture 10 is retained to the hard disk cage 32 and supports the hard disk 20, the operator does not need to hold the hard disk 20, which decreases work intension of the operator and improves the installation efficiency of the hard disk 20.

Additionally, after the hard disk 20 is inserted into the hard disk cage 32, the hard disk 20 at least contacts the surface 1322 of the main plate 132 of the supporting portion 13 and the abutting portion 14, the hard disk 20 is lift toward the sidewall 34 of the computer 30 by support of the main plate 132 and the abutting portion 14 of the fixture 10, so, the hard disk 20 with small size such as 2.5 inches can also be fixed to the hard disk cage 32 by fixing holes of the hard disk 20 corresponding to fixing holes of the hard disk cage 32.

After the hard disk 20 is fixed to the hard disk cage 32, the fixture 10 is detached from the hard disk cage 32 via the slots 34 being disengaged with the hard disk cage 32, so the fixture 10 can be applied to repeat the installation of hard disks to computers.

It can be understood that, however, even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A fixture for installing a hard disk to a hard disk cage in a computer, the fixture comprising:
a holding portion; and
a supporting portion connecting with the holding portion, the supporting portion comprising a main plate and a side plate, a slot being defined between the main plate and the side plate, for receiving the hard disk cage and retaining the fixture to the hard disk cage.

2. The fixture of claim 1, wherein the main plate of the supporting portion comprises a surface for supporting the hard disk.

3. The fixture of claim 2, further comprising an abutting portion at a side of the supporting portion opposite to the holding portion.

4. The fixture of claim 3, wherein the abutting portion tilts toward the surface of the main plate of the supporting portion, for supporting the hard disk.

5. The fixture of claim 1, wherein the side plate of the supporting portion comprises a part parallel the main plate, the slot being defined between the part of the side plate and the main plate.

6. The fixture of claim 1, further comprising a connecting portion between the holding portion and the supporting portion, wherein the connecting portion connects the holding portion and the supporting portion.

7. The fixture of claim 6, wherein the connecting portion is between a middle part of the holding portion and a middle part of the supporting portion.

8. The fixture of claim 6, wherein the connecting portion comprises a surface for supporting the hard disk.

9. The fixture of claim 1, wherein the holding portion defines a concave facing the supporting portion.

10. The fixture of claim 1, wherein the holding portions comprises a surface for supporting the hard disk.

11. A fixture for installing a hard disk to a hard disk cage in a computer, the fixture comprising:
a holding portion for an operator holding thereon; and
a supporting portion connecting with the holding portion, the supporting portion comprising a main plate and a side plate bending from the main plate, two slots being defined between corresponding ends of the main plate and the side plate, the slots configured for receiving the hard disk cage and retaining the fixture to the hard disk cage.

12. The fixture of claim 11, wherein the main plate of the supporting portion comprises a plane surface for supporting the hard disk.

13. The fixture of claim 12, wherein the holding portion comprises a plane surface coplanar with the plane surface of the main plate of the supporting portion.

14. The fixture of claim 12, further comprising a connecting portion connecting the holding portion and the supporting portion.

15. The fixture of claim 14, wherein the connecting portion comprises a plane surface coplanar with the plane surface of the main plate of the supporting portion.

16. The fixture of claim 12, further comprising an abutting portion located at a side of the supporting portion opposite to the holding portion, wherein the abutting portion tilts towards the plane surface of the main plate of the supporting portion, for elastically pressing the hard disk.

17. The fixture of claim 16, further comprising a connecting portion between the holding portion and the supporting portion, wherein the abutting portion and the connecting portion are located two opposite sides of the supporting portion respectively and corresponding to each other.
